(19) United States
(12) Patent Application Publication
(10) Pub. No.: US 2026/0296680 A1
(43) Pub. Date: Oct. 1, 2026

(54) SMALL THRUSTER THROTTLE VALVE WITH INTEGRATED POSITIVE ISOLATION

(71) Applicant: California Institute of Technology, Pasadena, CA (US)

(72) Inventors: Kevin R. MARK, PASADENA, CA (US); Elizabeth JENS, PASADENA, CA (US); Cory A. TIMMONS, PASADENA, CA (US); Maggie M. STEWART, PASADENA, CA (US); Mark A. BALZER, PASADENA, CA (US); Frank Q. PICHA, PASADENA, CA (US); J. Morgan PARKER, PASADENA, CA (US)

(21) Appl. No.: 19/573,743

(22) Filed: Mar. 20, 2026

Related U.S. Application Data
(60) Provisional application No. 63/777,396, filed on Mar. 25, 2025.

(51) Int. Cl. B64G 1/40; F16K 1/38

(52) U.S. Cl. CPC B64G 1/402; F16K 1/38

(57) ABSTRACT

A small thruster throttle valve (STTV) assembly for fluid modulation is presented. The STTV assembly includes a housing defining a cavitating venturi and a modulating pintle configured for linear translation along a centerline to define a variable annular orifice. A magnetic circuit provides a passive magnetic bias to drive the modulating pintle to a seated position, forming a fluidic seal for positive isolation in the absence of electrical power. An actuator assembly is coupled to the modulating pintle via a pintle flexure that provides mechanical compliance to maintain coaxial alignment while decoupling the pintle from actuator misalignments. An electrical interface delivers power to generate an actuation force that overcomes the passive magnetic bias, permitting precision modulation while inducing cavitation at the throat to decouple propellant flow from downstream pressure fluctuation.

### CROSS REFERENCE TO RELATED APPLICATIONS

The present application claims priority to and the benefit of co-pending U.S. provisional patent application Ser. No. 63/777,396 entitled “Small Thruster Throttle Valve”, filed on Mar. 25, 2025, the disclosure of which is incorporated herein by reference in its entirety.

### STATEMENT OF GOVERNMENT GRANT

This invention was made with government support under Grant No. 80NM0018D004 awarded by NASA (JPL). The government has certain rights in the invention.

### TECHNICAL FIELD

The present disclosure relates generally to spacecraft propulsion systems and propellant flow control. More specifically, the disclosure relates to an integrated small thruster throttle valve (STTV) that utilizes a cavitating venturi and a modulating pintle to provide deep-throttling capability and integrated positive isolation.

### BACKGROUND

Landing spacecraft on planetary bodies, such as Mars, requires the ability to precisely modulate thruster output to manage descent velocity and ensure a soft landing. In current aerospace applications, deep-throttling capability is typically provided by valves designed for large-scale propulsion systems. The size and mass of these state-of-the-art throttle valves effectively set a minimum spacecraft mass of approximately 350 kg for missions requiring such functionality.

There is a significant technological gap for small-scale spacecraft landers, specifically those targeting a mass an order of magnitude smaller (e.g., approximately 35 kg). Enabling these smaller missions requires a throttle valve compatible with smaller thrusters, such as a 70-lbf-class (approximately 311-N-class) monopropellant thruster, that can maintain performance at reduced flow rates. Specifically, these missions require a valve capable of providing a linear throttling range of at least 10:1 (e.g., from 100% of rated flow down to 10% of rated flow).

Furthermore, traditional spacecraft propulsion architectures typically require a dedicated isolation valve to provide a high-fidelity seal during the launch and cruise phases to prevent propellant leakage. A separate, second valve is then utilized for throttling during the descent phase. This dual-valve configuration increases total system mass, adds mechanical complexity, and introduces additional failure points. Additionally, existing systems must address safety requirements by ensuring the valve defaults to a closed state in the event of a power loss (e.g., absence of electrical power) to prevent accidental leakage or inadvertently applied thrust during launch, cruise, or after landing.

Therefore, there is a motivation to develop a compact, integrated throttle valve compatible with smaller thrusters, such as a 70-lbf-class monopropellant thruster. Specifically, a need exists for a device that enables a new class of small-scale planetary landing missions by reducing the minimum spacecraft mass from the current state-of-the-art 350 kg to approximately 35 kg. Furthermore, there is a requirement for a system that eliminates the mass and complexity associated with separate isolation hardware by providing deep-throttling capability and positive isolation within a single valve assembly, while simultaneously ensuring robust, passive, fail-closed protection during launch and cruise environments.

Additionally, as such throttle valves are miniaturized, maintaining precise alignment between a drive mechanism and internal valve structures becomes increasingly difficult due to mechanical tolerances and thermal expansion. Such misalignments can lead to side-loading of a translating element, potentially causing mechanical binding or preventing the formation of a reliable fluidic seal. There is therefore a further need for a valve architecture capable of decoupling the alignment of a modulating member from a drive mechanism to ensure consistent performance despite internal mechanical offsets.

The above are motivation to the present teachings.

### SUMMARY

To address the aforementioned needs, the present disclosure provides a small thruster throttle valve (STTV) with integrated positive isolation. The STTV comprises a valve assembly and an actuator assembly integrated into a single unit. The valve assembly includes a cavitating venturi housing that defines an internal cavity and a modulating pintle. The interaction between the geometry of the modulating pintle and the internal cavity of the cavitating venturi housing provides a linear throttling range of at least 10:1 (e.g., from 100% of rated flow down to 10% of rated flow).

In one aspect of the present disclosure, the STTV provides integrated positive isolation. Specifically, a converging inlet of the internal cavity and a bulb feature of the pintle (e.g., pintle bulb) create a mechanical interface providing a sealing feature that allows the STTV to function as a shutoff valve, thereby eliminating the requirement for a separate, dedicated isolation valve within the propulsion system.

In another aspect of the present disclosure, the actuator assembly includes a magnetic circuit configured to provide a passive fail-closed and locking feature. The magnetic circuit is configured to drive the modulating pintle to a sealed position and maintain the sealed position in the event of a power loss. This provides passive protection against accidental leakage or inadvertently applied thrust during launch and cruise environments without requiring continuous power from the actuator.

The integration of the deep-throttling cavitating venturi, the positive isolation feature, and the fail-closed magnetic circuit results in a system that reduces spacecraft mass and complexity while enabling precise flow control for small-scale applications, such as a 70-lbf-class (approximately 311-N-class) monopropellant thruster.

According to a first aspect of the present disclosure, a throttle valve for fluid modulation is presented, comprising: a housing defining a centerline and a converging inlet, the converging inlet having a converging half-angle relative to the centerline and terminating at a throat for downstream flow of a fluid; and a modulating pintle aligned with the centerline and comprising a bulb and a downstream extension, wherein the modulating pintle is translatable along the centerline between: a first position where the bulb contacts the converging inlet to prevent the downstream flow through the throat; and a second position where the bulb is distant from the converging inlet to define a radial spacing between the downstream extension of the modulating pintle and the throat, the radial spacing configured to modulate the downstream flow.

According to a second aspect of the present disclosure, an integrated throttle valve system for propellant flow modulation is presented, comprising: a housing defining a centerline and an internal cavity forming a cavitating venturi, the internal cavity comprising a converging inlet, a throat, and a diverging diffuser arranged sequentially along the centerline; a modulating pintle translatable along the centerline within the internal cavity and comprising a bulb; an actuator assembly coupled to the housing and comprising a mechanical drive train configured to translate the modulating pintle to define a variable annular orifice between the modulating pintle and the throat to modulate a propellant flow; and a magnetic circuit positioned within the actuator assembly and configured to generate a passive latching force that biases the modulating pintle toward a position where the bulb contacts the converging inlet to provide positive isolation of the propellant flow in a fail-closed state.

According to a third aspect of the present disclosure, a method for propellant flow modulation in a spacecraft propulsion system is presented, the method comprising: translating a modulating pintle along a centerline of a housing to define a variable annular orifice between the modulating pintle and a throat of the housing; inducing cavitation at the throat to decouple a propellant flow from downstream pressure fluctuations; modulating the propellant flow through a linear range of at least 10:1 based on a longitudinal position of the modulating pintle; and biasing a bulb of the modulating pintle toward a converging inlet of the housing using a passive magnetic force to form a fluidic seal for positive isolation of the propellant flow during a non-operational state.

Further aspects of the disclosure are shown in the specification, drawings and claims of the present application.

### BRIEF DESCRIPTION OF DRAWINGS

The accompanying drawings, which are incorporated into and constitute a part of this specification, illustrate one or more embodiments of the present disclosure and, together with the description of example embodiments, serve to explain the principles and implementations of the disclosure; the drawings are not necessarily to scale and certain features may be shown exaggerated in scale or in somewhat schematic form, and some details of conventional elements may not be shown, all in the interest of clarity and conciseness.

FIG. 1 is a side view of a small thruster throttle valve (STTV) assembly, illustrating external envelopes of an actuator assembly and a valve assembly, according to an embodiment of the present disclosure.

FIG. 2 is a cross-sectional view of the STTV assembly taken along section A-A of FIG. 1, illustrating an internal structural arrangement including a magnetic circuit and a modulating pintle.

FIG. 3 is a detailed cross-sectional view of the valve assembly, illustrating a mechanical interface providing a sealing feature between the modulating pintle and an internal cavity.

FIG. 4 is a schematic cross-sectional view of the internal cavity, illustrating a converging inlet, a throat, and a diverging diffuser geometry.

FIG. 5A is a schematic view of the modulating pintle, illustrating the pintle bulb and a tapered throttling region.

FIG. 5B is a schematic view of the modulating pintle, illustrating an angular mismatch and a seal region of the pintle bulb.

FIG. 6 is a detailed view illustrating an alignment and radial clearance between the modulating pintle and the venturi housing.

FIG. 7 is a performance characteristic diagram illustrating throttle behavior as a function of stroke position.

FIG. 8 is the cross-sectional view of the actuator assembly, illustrating a mechanical drive train and associated mechanical components.

FIG. 9 is a detailed cross-sectional view of the actuator assembly, illustrating a magnetic lock feature of the magnetic circuit.

FIG. 10 is a schematic view of a pintle drive interface, illustrating a flexible drive geometry.

Like reference numbers and designations in the various drawings indicate like elements.

### DETAILED DESCRIPTION

The following detailed description provides a description of various embodiments of the present disclosure. This description is not to be taken in a limiting sense and is made for the purpose of illustrating the general principles of the disclosure—the scope of the disclosure is defined by the appended claims.

As used herein, “deep-throttling” (or “deep-throttling capability”) refers to a range of fluid modulation (e.g., a linear throttling range of at least 10:1) configured to control a flow rate of a fluid (e.g., a propellant) from a maximum state (e.g., 100% of rated flow) to a minimum state (e.g., 10% or less of rated flow) and vice versa.

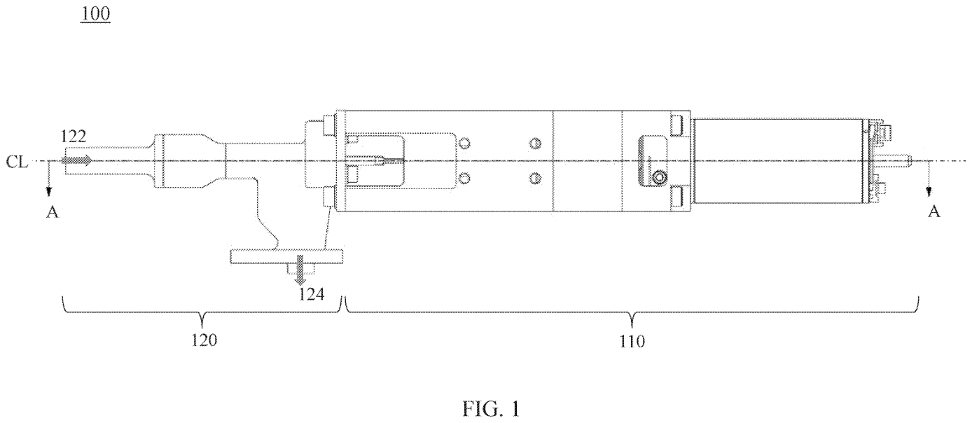

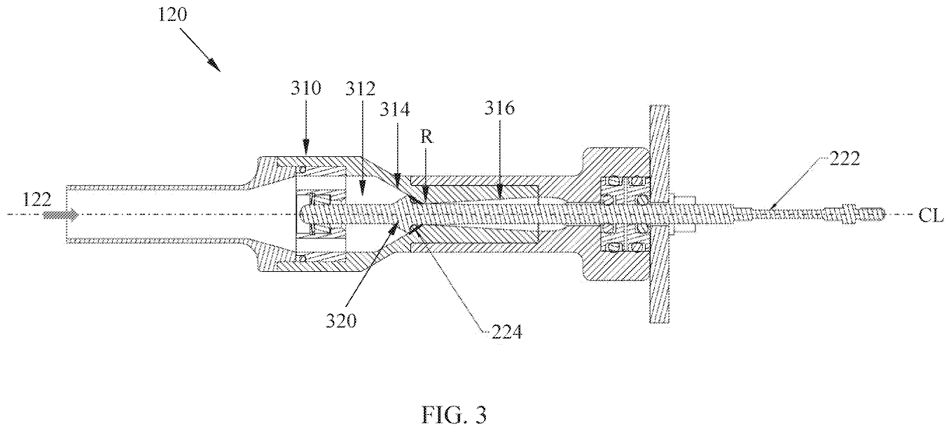

FIG. 1 shows a side view of a small thruster throttle valve (STTV) assembly (100) according to an embodiment of the present disclosure. The STTV assembly (100) includes an actuator assembly (110) and a valve assembly (120). The STTV assembly (100) defines a centerline, CL, extending along a longitudinal extension of the assembly. In some embodiments, the STTV assembly (100) is substantially symmetrical about the centerline, CL. The external profiles (e.g., envelopes) of the actuator assembly (110) and the valve assembly (120) are configured for integration into a spacecraft propulsion system, such as those utilized in small-scale spacecraft landers. As illustrated, the valve assembly (120) is coupled to the actuator assembly (110). Generally, the actuator assembly (110) is configured to house electromechanical components that generate and control mechanical motion, while the valve assembly (120) is configured to receive said mechanical motion to modulate propellant flow, from a fluid inlet (122) to a fluid outlet (124) through an internal cavity (e.g., 312 of FIG. 3), along the centerline, CL, of the STTV, thereby controlling a thrust level of the spacecraft propulsion system.

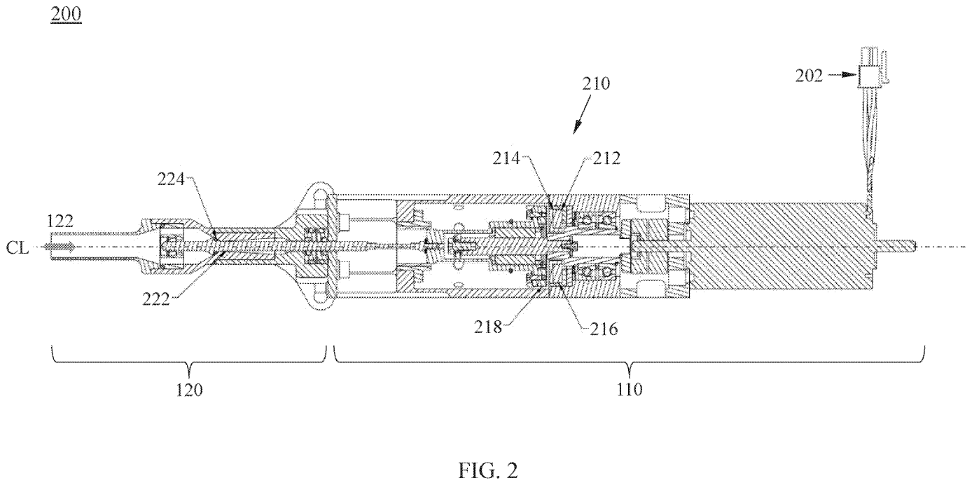

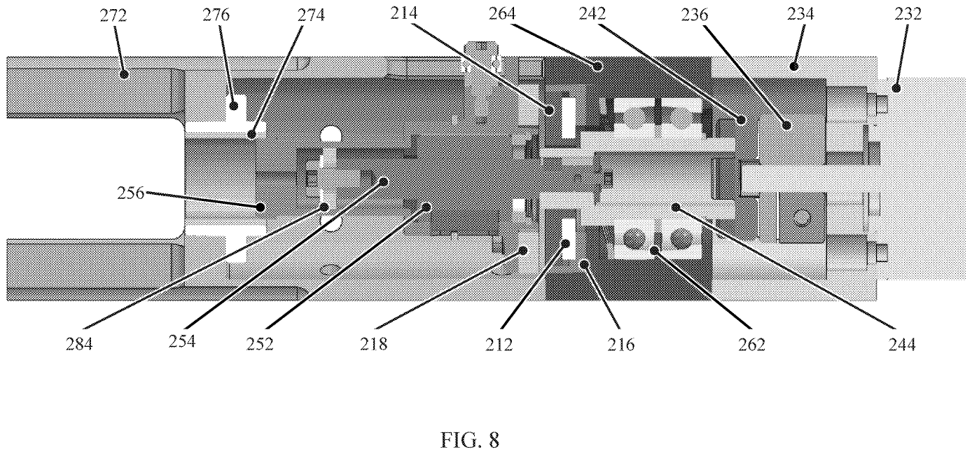

FIG. 2 represents a cross-sectional view (200) of the STTV assembly (100) taken along section A-A of FIG. 1. As illustrated, an internal structural arrangement of the STTV assembly (100) includes a magnetic circuit (210) comprising elements (212, 214, 216, 218), an electrical interface (e.g., an electrical pigtail 202), and a modulating pintle (222). According to an embodiment of the present disclosure, the magnetic circuit (210) is positioned within the actuator assembly (110) and comprises a magnet (212), a magnetic circuit holder (214), a magnetic circuit pole (216), and a magnetic shaft pole (218). The electrical interface (202) is configured to provide electrical communication between an external power source and the internal drive components (e.g., the actuator 232 of FIG. 8) of the actuator assembly (110). The modulating pintle (222) is coaxially aligned with the centerline, CL, and is configured to translate longitudinally relative to the valve assembly (120) to modulate or stop the flow of propellant from the upstream side (e.g., at fluid inlet 122) toward the downstream side (e.g., at fluid outlet 124) of the STTV assembly (100). The valve assembly (120) is configured to provide a mechanical interface (224) between (respective surfaces of) the internal cavity (312) and the modulating pintle (222) such as to form a (fluidic) seal, thereby producing positive isolation. Such seal, which may be referred to as “positive isolation”, is designed to stop the flow of propellant downstream from the valve assembly (120).

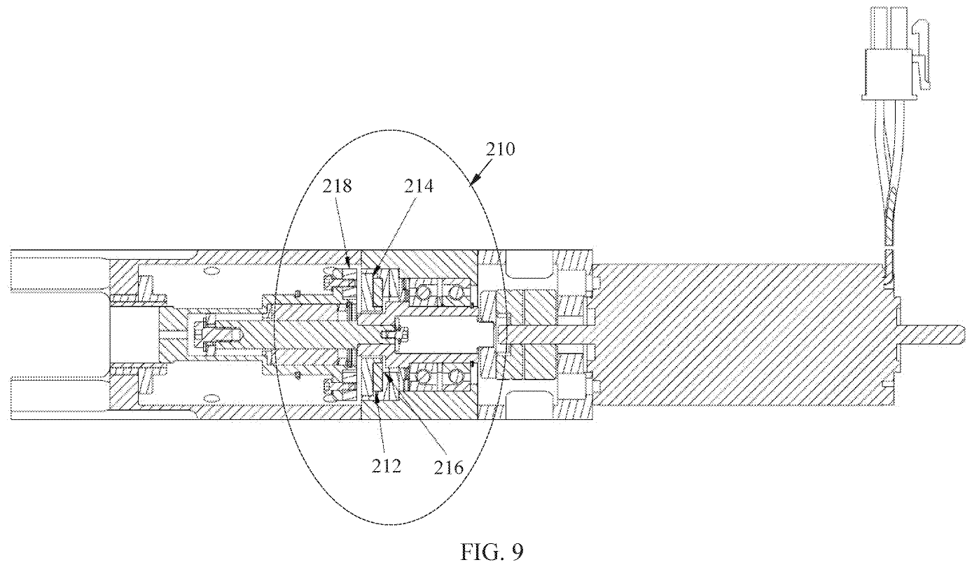

With continued reference to FIG. 2, the magnetic circuit (210) is configured to provide a fail-closed and locking feature. Specifically, a magnetic force generated by the magnet (212) is directed through the magnetic circuit pole (216) and the magnetic shaft pole (218) to bias the modulating pintle (222) and engage the mechanical interface (224). The magnetic circuit holder (214) is configured to maintain the orientation and position of the magnetic components within the actuator assembly (110). This arrangement ensures that the modulating pintle (222) is driven to a sealed position and maintained in said position to engage the mechanical interface (224) when the actuator is unpowered. Conversely, the electrical interface (202) is configured to deliver electrical power to the actuator (e.g., 232 of FIG. 8) to provide a mechanical force sufficient to overcome the passive latching force generated by the magnet (212), thereby permitting active translation and modulation of the modulating pintle (222). Further details regarding the magnetic circuit (210) and the provided magnetic lock feature are described below in the present disclosure with reference to FIG. 9.

FIG. 3 shows a detailed cross-sectional view of a valve assembly (120) illustrating a mechanical interface (224, highlighted for clarity) between a modulating pintle (222) and a cavitating venturi housing (310). The cavitating venturi housing (310) is an outer housing that defines an internal cavity (312). This internal cavity (312) forms a fluid flow path and is referred to herein as a cavitating venturi (e.g., 312). The internal cavity (312) is bounded by internal surfaces of the cavitating venturi housing (310) comprising a converging inlet (314) and a diverging diffuser (316). A throat, R, is arranged at, or defines, a transition between the converging inlet (314) and the diverging diffuser (316). The modulating pintle (222) includes a bulb feature (320) positioned at an upstream end (e.g., a distal end) of the modulating pintle (222). A sloped region of the bulb feature (320) provides a first contact surface of the mechanical interface (224), and the converging inlet (314) provides a second contact surface of the mechanical interface (224). Both the first contact surface and the second contact surface converge in a downstream direction toward the throat, R. An interaction between the first contact surface and the second contact surface creates a mechanical seal at the mechanical interface (224) when the modulating pintle (222) is in a closed position (e.g., position shown in FIG. 3) to provide positive isolation and stop a flow of propellant from an upstream side (e.g., inlet 122) toward a downstream side (e.g., outlet 124) of the STTV assembly (100).

According to some embodiments of the present disclosure, the cavitating venturi housing (310) and/or the modulating pintle (222) may each be provided by a single structure, including a monolithic structure. Such structure may be fabricated through a subtractive and/or an additive manufacturing technique, that may include, for example, 3D manufacturing techniques. According to further embodiments of the present disclosure, the cavitating venturi housing (310) and/or the modulating pintle (222) may each be formed from a plurality of parts that may be attached to one another to form a final assembly. In some embodiments, at least the internal surfaces of the cavitating venturi housing (310) (e.g., the converging inlet (314) and the diverging diffuser (316)) and the modulating pintle (222) (e.g., the bulb feature (320)) that define, or are in contact with, the fluid flow path, are constructed from hydrazine-compatible materials, such as, for example, a hydrazine-compatible corrosion-resistant steel and/or a titanium alloy.

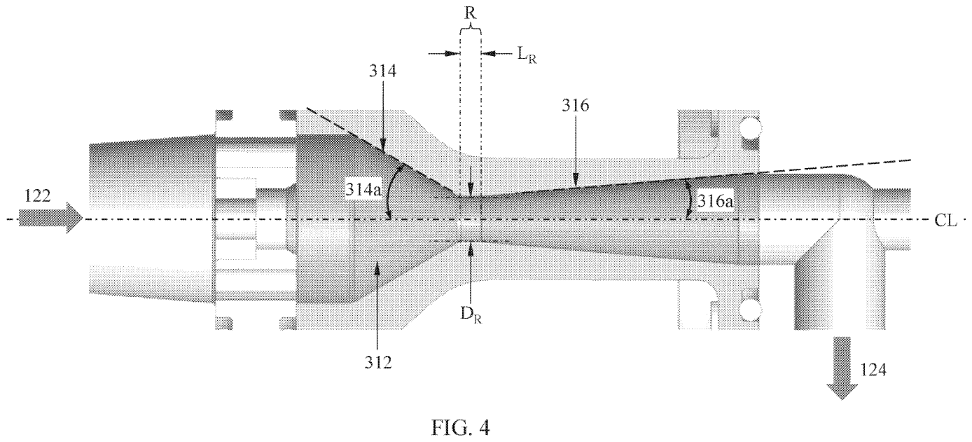

FIG. 4 is a schematic cross-sectional view of the internal cavity (312) illustrating the geometric parameters of the cavitating venturi. In this view, the modulating pintle (e.g., 222 of FIG. 3) is omitted to clearly illustrate the internal geometry of the fluid flow path. The internal cavity (312) defines a specific geometry selected to facilitate fluidic behaviors such as cavitation and pressure recovery. The converging inlet (314) is configured to direct propellant flow toward the throat, R, while providing a seating surface for the modulating pintle (222), for example, during the closed position of the modulating pintle (222). Furthermore, the converging inlet (314) defines a converging half-angle (314a) relative to the centerline, CL. The converging half-angle (314a) is an angle selected to promote predictable flow control and efficient cavitation through a stable fluid transition into the throat, R. In some embodiments, the converging half-angle (314a) may be in a range of approximately 25 degrees to 45 degrees. According to a non-limiting exemplary embodiment of the present disclosure, the converging half-angle (314 a) is approximately 30 degrees.

With continued reference to FIG. 4, a throat, R, is configured to set the propellant flow rate and is characterized by a throat length, L_{R}, along a longitudinal direction and a throat diameter, D_{R}, extending across a plane orthogonal to the longitudinal direction. As established, the throat, R, defines the transition between the converging inlet (314) and the diverging diffuser (316). In some embodiments, the throat length, L_{R}, is selected to be small relative to the throat diameter, D_{R}, to ensure the valve assembly (120) functions as a cavitating venturi, e.g., by inducing cavitation to decouple the flow rate from downstream pressure fluctuations. According to some embodiments, the throat length, L_{R}, is selected such that a ratio of the throat length to the throat diameter (L_{R}/DR) is in a range of 0.1 to 0.5. For example, the throat length, L_{R}, may be approximately 0.76 mm (e.g., 0.03 inches) (which represents a ratio of approximately 0.22), or otherwise be less than or approximately equal to a throat radius (e.g., 0.5×D_{R}) of the throat, R, and the throat diameter, D_{R}, may be approximately 3.49 mm (e.g., 0.1374 inches).

With further reference to FIG. 4, according to an embodiment of the present disclosure, the diverging diffuser (316) is configured to facilitate pressure recovery as the propellant moves downstream toward the fluid outlet (124) and defines a diverging half-angle (316a) relative to the centerline, CL. In some embodiments, the diverging half-angle (316a) is selected to be small to promote said pressure recovery, such as an angle less than or equal to approximately 5 degrees (e.g., in a range from about 3 degrees to about 5 degrees). It should be noted that the specific values for the converging half-angle (314a), the throat length, L_{R}, the throat diameter, D_{R}, and the diverging half-angle (316a) are exemplary and non-limiting. These parameters may be adjusted or scaled to accommodate different propellant flow requirements and/or to improve packaging and manufacturability without changing the overall function of the valve assembly (e.g., 120 of FIG. 3).

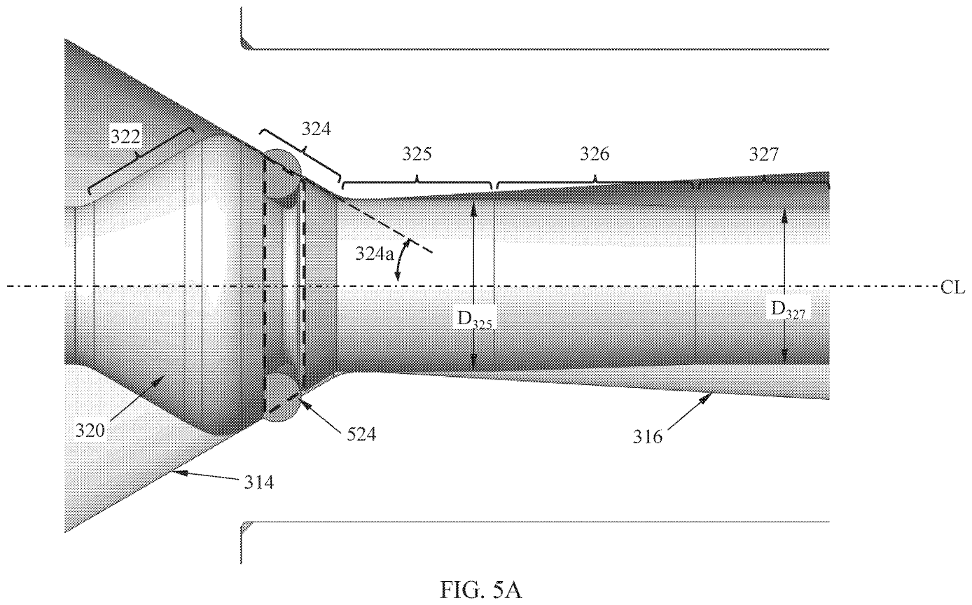

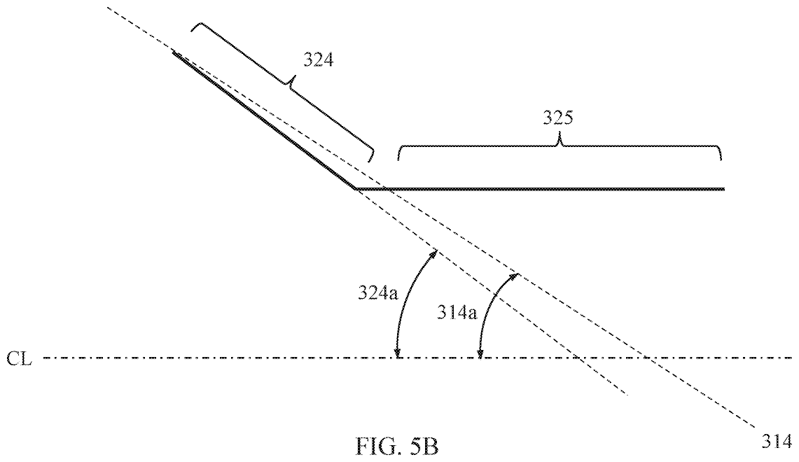

FIG. 5A is a detailed side view of the modulating pintle (222) illustrating its geometric features and mechanical interaction with the internal surfaces of the cavitating venturi housing (310). As illustrated, the bulb feature (320) of the modulating pintle (222) defines a dual-conical profile comprising an upstream conical surface (322) and a downstream conical surface (324) arranged back-to-back. The upstream conical surface (322) is divergent in the downstream direction and is configured to direct propellant flow toward the internal surfaces of the converging inlet (314). The downstream conical surface (324) serves as a conical sealing surface configured to interface with the converging inlet (314) to form the mechanical interface (224). According to an embodiment of the present disclosure, the downstream conical surface (324) may provide a slope that, by design, slightly differs from the slope of the converging inlet (314).

As shown in FIG. 5A, a slope of the downstream conical surface (324) may be defined by a converging half-angle (324a) relative to the centerline, CL. With additional reference to FIG. 5B, according to an embodiment of the present disclosure, the converging half-angle (314a) defined by the converging inlet (314) differs slightly from the half-angle (324a) of the downstream conical surface (324) of the pintle.

With continued reference to FIGS. 5A and 5B, according to an embodiment of the present disclosure, the downstream conical surface (324) defines a seal region configured to concentrate sealing force for positive isolation. Specifically, the seal region is provided by the downstream conical surface (324) of the pintle having a converging half-angle (324a) that is intentionally designed to be greater than (e.g., slightly differs from) the converging half-angle (314a) of the converging inlet (314). This mismatch between the converging half-angles (324a) and (314a), wherein the converging half-angle (324a) exceeds (e.g., is greater than) the converging half-angle (314a), ensures that the mechanical sealing force is focused onto a small region near the apex of the bulb feature (320) rather than being distributed across the entire downstream conical surface (324). In some embodiments, the seal region may be lapped on assembly to ensure a high-precision, leak-tight fit. According to an embodiment of the present disclosure, the angular mismatch between the converging half-angle (324a) of the bulb feature (320) and the converging half-angle (314a) of the converging inlet (314) is within a range of approximately 0.5 degrees to approximately 5 degrees (e.g., 0.5 to 5 degrees). According to an exemplary embodiment, the angular mismatch is approximately 2 degrees. For example, the converging half-angle (324a) may be approximately 32 degrees and the converging half-angle (314a) may be approximately 30 degrees.

In an embodiment of the present disclosure, the mechanical interface (224) may be configured to provide a redundant non-metallic seal in addition to the primary metal-to-metal contact described above (e.g., between the converging inlet 314 and the downstream conical surface 324). In this configuration, the downstream conical surface (324) of the bulb feature (320) includes a radial sealing feature, such as a circumferential groove (524, e.g., a gland) shown in FIG. 5A, which is configured to retain a member (e.g., an elastomeric O-ring) that is softer and more compliant than the converging inlet (314). According to this embodiment, positive isolation is achieved via a radial O-ring seal fitted into the circumferential groove (524) that interfaces with the internal surface of the converging inlet (314) when the modulating pintle (222) is in the closed position. This O-ring implementation may be utilized as a complement to the metal-on-metal sealing method to ensure zero-leakage performance under specific operating conditions.

As shown in FIG. 5A, the modulating pintle (222) comprises a series of contiguous structural sections (e.g., segments) arranged sequentially from an upstream direction to a downstream direction along the centerline, CL. These sections include a bulb feature (320), followed by a first cylindrical section (325), a frustoconical tapered section (326), and a second cylindrical section (327). The bulb feature (320) is configured to provide positive isolation against the converging inlet (314), while the subsequent sections (325, 326, 327) are configured to translate through the throat, R, (e.g., described with reference to FIG. 4) to modulate the propellant flow rate.

With continued reference to FIG. 5A, the frustoconical tapered section (326) serves as the primary metering element and is defined by a constant taper with, for example, a half-angle of approximately 2 degrees. This section (326) provides a structural transition from a larger constant diameter, D₃₂₅, of the first cylindrical section (325) to a smaller constant diameter, D₃₂₇, of the second cylindrical section (327). This specific taper allows for a linear throttle setting relative to a (longitudinal) position of the modulating pintle (222). According to an exemplary embodiment of the present disclosure, the modulating pintle (222) is sized for a 100% flow state (of propellant fluid) when the smaller diameter, D₃₂₇, of the second cylindrical section (327) is within the throat, R, and for a 10% flow state of when the larger diameter, D₃₂₅, of the first cylindrical section (325) enters the throat, R.

According to an exemplary embodiment of the present disclosure, the 100% flow state is achieved with an outer diameter, D₃₂₇, of approximately 3.175 mm (e.g., 0.125 inches) at the throat, R. To achieve deep throttling, the modulating pintle (222) is moved to a nearly closed position, presenting an outer diameter, D₃₂₅, of approximately 3.45 mm (e.g., 0.136 inches) at the throat, R, to reach the 10% flow state. At this 10% flow state, the radial clearance between the modulating pintle (222) and the throat diameter, D_{R}, is reduced to approximately 0.018 mm (e.g., 0.0007 inches). In this context, the radial clearance refers to the uniform annular gap maintained between the outer diameter of the modulating pintle (222) and the (inner) diameter, D_{R}, of the throat, R, across the entirety of their circumferential interface. This uniform annular gap defines an annular orifice through which the propellant flows.

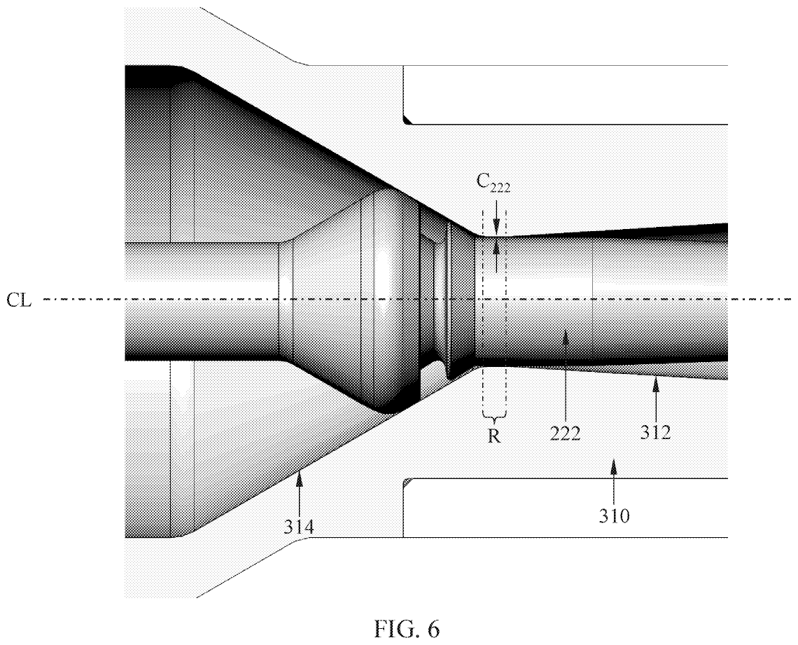

FIG. 6 is a detailed cross-sectional view illustrating the mechanical interface and coaxial alignment between the modulating pintle (222) and the throat, R, of the cavitating venturi housing (310). As shown in the cross-section, the radial clearance, C₂₂₂, is maintained across the entirety of the circumferential interface between the modulating pintle (222) and the housing (310, e.g., inner surface of the internal cavity 312). When the valve assembly (120) is in a deep-throttling state (e.g., the 10% flow state), this gap is reduced to approximately 0.018 mm (0.0007 inches). To prevent mechanical interference and ensure a symmetric flow field, the valve assembly (120) may be precision-machined to ensure that the modulating pintle (222) remains concentric with the throat, R, throughout its full range of longitudinal translation. This concentricity ensures that, for example, the 0.018 mm (0.0007 inches) clearance, C₂₂₂, is substantially equal at any circumferential position around the modulating pintle (222).

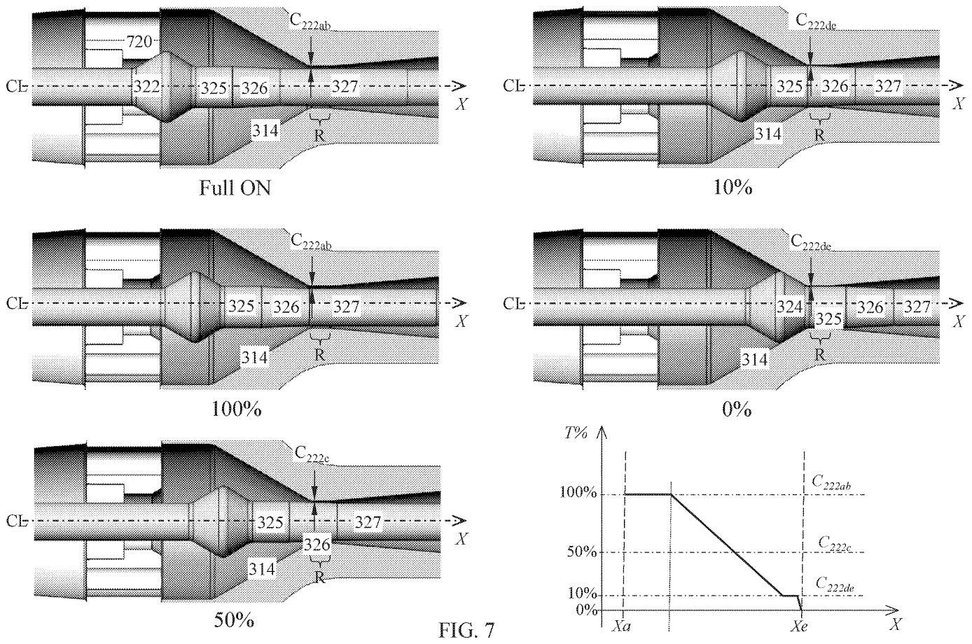

FIG. 7 illustrates the operational stroke and resulting throttle performance (e.g., throttle percentage, T %) of the valve assembly (120) as a function of the longitudinal position, X, of the modulating pintle (222) along the centerline, CL. The longitudinal position X is bounded by a first extreme (upstream) position, Xa, and a second extreme (downstream) position, Xe.

The first extreme position, Xa, corresponds to a “Full ON” state (100% throttle). At position Xa, the modulating pintle (222) translates upstream until the upstream conical surface (322) of the bulb feature (320) reaches a mechanical hard stop provided by an upstream internal structure (720), such as a guide bushing. At this position, the second cylindrical section (327) is positioned within the throat, R, resulting in a maximum operational radial clearance C_{222ab} that facilitates maximum rated propellant flow.

As the actuator assembly (e.g., 110 of FIG. 2) drives the modulating pintle (222) downstream from Xa, the frustoconical tapered section (326) enters the throat, R. During this translation, the varying diameter of the frustoconical tapered section (326) creates a variable radial clearance (e.g., C_{222c}, C_{222de}), thereby defining a variable annular orifice. As indicated in the performance graph of FIG. 7, this geometric transition results in a throttle percentage (T %) that decreases linearly from the 100% flow state toward a 50% flow state and then a 10% flow state as a function of the longitudinal position X.

Continued downstream translation brings the modulating pintle (222) to a position where the first cylindrical section (325) enters the throat, R. At this stage of the stroke, the radial clearance at the throat, R, reaches a minimum operational clearance C_{222de}. This position establishes a minimum flow state (e.g., 10% throttle). However, as the first cylindrical section (325) continues to translate through the throat, R, the bulb feature (320) simultaneously moves into closer proximity with the converging inlet (314). Consequently, the modulation of propellant flow transitions from being area-controlled at the throat, R, to being proximity-controlled at the converging inlet (314). As the downstream conical surface (324) of the bulb feature (320) approaches the converging inlet (314), it gradually restricts the flow toward a fully closed state (0% throttle) independently of the dimensions of the throat, R, and/or clearance (e.g., C_{222de}). The stroke concludes at the second extreme (downstream) position, Xe, when these surfaces make full mechanical contact to form the mechanical interface (224), providing positive isolation.

According to a non-limiting exemplary embodiment of the present disclosure, the specific dimensions of the valve assembly (120) may be selected to remain compatible with a 70-lbf-class monopropellant thruster. To support this class of propulsion, the STTV (e.g., 100 of FIG. 1) can be configured to accommodate a max flow rate of approximately 0.14 kg/s to 0.15 kg/s (e.g., of hydrazine propellant) at an inlet pressure ranging from approximately 400 psia to 750 psia. To achieve these flow characteristics, the internal cavity (312) may be configured with a throat diameter, D_{R}, of approximately 3.49 mm (0.1374 inches) and a throat length, L_{R}, of approximately 0.76 mm (0.030 inches). Furthermore, the diverging diffuser (316) may be provided with a diverging half-angle (316 a) of approximately 3 degrees to 5 degrees (e.g. 3.5 degrees) to optimize pressure recovery.

According to a non-limiting exemplary embodiment of the present disclosure, the modulating pintle (222) may be configured with a total stroke from the first extreme (upstream) position, Xa, to the second extreme (downstream) position, Xe, of approximately 9.6 mm to 9.8 mm. Within this range, the functional stroke, extending from the fully closed state (0% throttle) to the 100% flow state, is approximately 6.9 mm to 7.2 mm. This functional stroke length is primarily defined by the longitudinal lengths of the first cylindrical section (325) and the frustoconical tapered section (326), as the final seating transition of the bulb feature (320) occurs concurrently with the translation of the first cylindrical section (325). At the 100% flow state, the second cylindrical section (327) presents an outer diameter of approximately 3.175 mm (0.125 inches) within the throat, R. As the modulating pintle (222) translates downstream toward the minimum flow state, the first cylindrical section (325) presents an increased outer diameter of approximately 3.45 mm (0.136 inches). This reduces the minimum operational clearance, C_{222de}, to approximately 0.018 mm (0.0007 inches), thereby enabling the required 10:1 throttling ratio for small-scale landing maneuvers.

FIG. 8 is the cross-sectional view of the (STTV) actuator assembly (110) of FIG. 2, illustrating a mechanical drive train and associated structural components. While the magnetic circuit (210) described in FIG. 2 is configured to bias the modulating pintle (222) toward the sealing feature (224) (e.g., to maintain a latched state), the mechanical drive train shown in FIG. 8 is configured to overcome the magnetic force and translate the modulating pintle (222) along the centerline, CL, to modulate propellant flow.

At a high level, the mechanical drive train of FIG. 8 comprises a plurality of functional subassemblies organized to convert electrical energy into linear displacement. Specifically, a drive power subassembly (232, 234, 236, e.g., 230's) is configured to generate rotational torque, and a power transmission subassembly (242, 244, e.g., 240's) is configured to transmit said rotational torque. A motion conversion subassembly (252, 254, 256, e.g., 250's) is configured to convert the rotational torque into linear translation of the modulating pintle (222) along the centerline, CL. To maintain the structural alignment and operational limits of the mechanical drive train, a rotational support subassembly (262, 264, e.g., 260's) is configured to rotatably support the rotating components of the mechanical drive train (e.g., a ball screw coupler shaft (244)), a translational guidance subassembly (272, 274, 276, e.g., 270's) is configured to provide radial constraint for the translating components of the mechanical drive train (e.g., an output drive shaft (256)) and structural enclosure for the mechanical drive train (e.g., via a mechanical housing (272)), and a stroke limit subassembly (284, e.g., 280's) is configured to define physical boundaries for the linear translation of the modulating pintle (222).

According to an embodiment of the present disclosure, and as shown in FIG. 8, the drive power subassembly (230's) includes an actuator (232) (e.g., a brushless DC motor), a motor mount (234) (e.g., constructed of an aluminum alloy,), and a motor coupler shaft (236) (e.g., constructed of an aluminum alloy. The actuator (232) is rigidly secured within the actuator assembly (110) by the motor mount (234), and the rotational torque is delivered via the motor coupler shaft (236).

According to an embodiment of the present disclosure, and as shown in FIG. 8, the power transmission subassembly (240's) includes an Oldham disc (242) (e.g., constructed of a polymeric material,) and the ball screw coupler shaft (244). The Oldham disc (242) interfaces with the motor coupler shaft (236) and the ball screw coupler shaft (244) to provide a flexible drive geometry that accommodates mechanical misalignments between the drive power subassembly (230's) and the motion conversion subassembly (250's).

The motion conversion subassembly (250's) shown in FIG. 8 is configured to transform the rotational torque transmitted by the power transmission subassembly (240's) into a precise longitudinal translation of the modulating pintle (222) along the centerline, CL. According to an embodiment of the present disclosure, the motion conversion subassembly (250's) includes a ball nut (252) (e.g., a thin profile actuator (TPA) ball nut), a ball screw (254) (e.g., a TPA ball screw), and the output drive shaft (256) (e.g., constructed of a corrosion-resistant steel,). The ball nut (252) is configured to drive the ball screw (254) longitudinally in response to the rotation of the ball screw coupler shaft (244). The output drive shaft (256) couples the ball screw (254) to the modulating pintle (222) to transmit this linear translation.

The rotational support subassembly (260's) is configured to maintain the axial and radial alignment of the rotating components within the mechanical drive train. According to an embodiment of the present disclosure, and as shown in FIG. 8, the rotational support subassembly (260's) includes a plurality of angular contact bearings (262) (e.g., Misumi/NSK bearings), a bearing mount (264) (e.g., constructed of an aluminum alloy). The angular contact bearings (262) are seated within the bearing mount (264), preloaded and axially retained by the magnetic circuit (210) to rotatably support the ball screw coupler shaft (244) during operation of the STTV assembly (100).

The translational guidance subassembly (270's) is configured to provide the structural envelope for the mechanical drive train and ensure radial stability of the translating components. According to an embodiment of the present disclosure, and as shown in FIG. 8, the translational guidance subassembly (270's) includes the mechanical housing (272) (e.g., constructed of a corrosion-resistant steel), a guide bushing (274) (e.g., constructed of a low-friction polymeric material such as polyacetal), and a close out (276) (e.g., constructed of an aluminum alloy). The guide bushing (274) is positioned to radially constrain the output drive shaft (256) along the centerline, CL, while the mechanical housing (272) and close out (276) enclose the drive train components within the actuator assembly (110).

The stroke limit subassembly (280's) is configured to define the physical boundaries for the linear translation of the modulating pintle (222) to prevent internal mechanical interference. According to an embodiment of the present disclosure, and as shown in FIG. 8, the stroke limit subassembly (280's) includes a positive bumper (284) (e.g., constructed of a polymeric material such as polyacetal). The positive bumper (284) is configured to provide a physical hard stop for a fully extended position of the modulating pintle (222). In the fully retracted position, the modulating pintle is physically hard stopped against the sealing feature within the valve (224), leaving a small gap between the motion conversion subassembly (250's) and the magnetic circuit (210) in the actuator assembly (110).

While the mechanical drive train of FIG. 8 provides the active force required for modulation of the throttle, the actuator assembly (110) further incorporates passive features to ensure system integrity during non-operational periods. FIG. 9 is a detailed cross-sectional view of the actuator assembly (110), illustrating a magnetic lock feature of the magnetic circuit (210). This feature is specifically configured to provide a launch-lock and fail-closed capability of the STTV assembly (100).

As shown in FIG. 9, the magnetic circuit (210) includes a magnet (212) (e.g., a permanent magnet) disposed within a magnetic circuit holder (214). The magnet (212) is arranged to direct magnetic flux through a stationary magnetic circuit pole (216) toward a magnetic shaft pole (218) that translates with the modulating pintle (222). With additional reference to FIG. 7, when the modulating pintle (222) is driven to the second extreme (downstream) position, Xe, the proximity between the magnetic circuit pole (216) and the magnetic shaft pole (218) minimizes the magnetic reluctance of the magnetic circuit (210, e.g., the opposition to the flow of magnetic flux through the materials). This reduction in magnetic reluctance results in a latched state, wherein a passive latching force is generated that is sufficient to maintain the mechanical interface (224) between the bulb feature (320) and the converging inlet (314).

It should be noted that the mechanical interface (224) serves as the primary propellant seal, while the (above described) latched state provides an auxiliary holding force to ensure said seal remains effective even in the absence of electrical power. This configuration prevents propellant leakage during high-vibration or non-operational environments, such as during launch and cruise phases. To exit the latched state and resume active flow control, the actuator (232) described in FIG. 8 is energized to provide a mechanical actuation force sufficient to overcome the magnetic attraction. This force increases the magnetic reluctance by inducing mechanical separation between the magnetic circuit pole (216) and the magnetic shaft pole (218), thereby permitting the modulating pintle (222) to resume translation toward the first extreme (upstream) position, Xa.

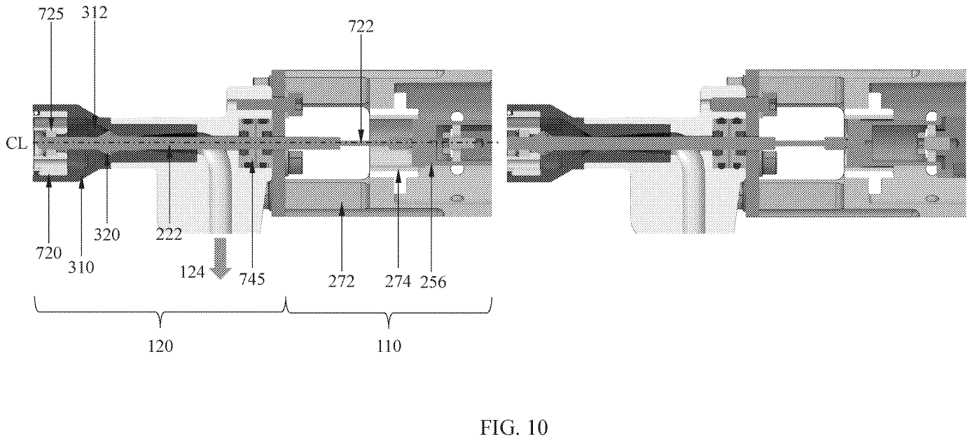

While the magnetic circuit (210) provides a passive fail-closed and locking feature as described with reference to FIG. 9, the structural connection between the actuator assembly (110) and the valve assembly (120) is further configured to manage internal alignment. FIG. 10 provides two schematic views of a pintle drive interface, where the view on the left illustrates the modulating pintle (222) in a seated position at an outmost downstream position (e.g., Xe of FIG. 7) and the view on the right illustrates the modulating pintle (222) at an outmost upstream position (e.g., Xa of FIG. 7). It is noted that these outmost downstream/upstream positions correspond to the physical boundaries defined by the stroke limit subassembly (e.g., 284 FIG. 8) and by the mechanical interface (224) between the pintle bulb (320) and the converging inlet (314). As illustrated in FIG. 10, the modulating pintle (222) further comprises a pintle flexure (722) positioned in a downstream region of the modulating pintle (e.g., downstream of the second cylindrical section 327 of FIG. 5A). The pintle flexure (722) is designed to flex or deflect to maintain the coaxial alignment of the modulating pintle (222) with respect to the internal cavity (312) of the cavitating venturi housing (310). As used herein, the “pintle drive interface” refers to the mechanical assembly and structural coupling configured to translate the linear motion provided by the motion conversion subassembly (e.g., 250's of FIG. 8) of the actuator assembly (110) to the modulating pintle (222) while managing axial alignment and accommodating mechanical tolerances.

With continued reference to FIG. 10, the flexible geometry provided by the pintle flexure (722) allows the modulating pintle (222) to accommodate angular or radial misalignment between the valve assembly (120) and the actuator assembly (110) without binding. Structurally, the pintle flexure (722) is defined by a substantially reduced diameter relative to the upstream sections (e.g., 325-327 of FIG. 5A). For example, while the upstream (metering) sections (e.g., 325-327 of FIG. 5A) are sized to maintain fluid modulation and structural integrity under pressure, the pintle flexure (722) may be defined by a substantially reduced diameter relative to these upstream sections. In some embodiments, the ratio of the diameter of the pintle flexure (722) to the diameter of the adjacent second section (e.g., 327 of FIG. 5A) may be within a range of approximately 0.4:1 to 0.8:1.This specific geometric ratio ensures the modulating pintle (222) is compliant enough to deflect under misalignment while providing a sufficient margin to transmit axial loads from the actuator assembly (110).

Furthermore, the length of the pintle flexure (722) may be sized relative to the total length of the upstream portions (e.g., 325-327 of FIG. 5A) of the modulating pintle (222) extending to the bulb feature (320). This allows a length-to-diameter aspect ratio between the pintle flexure (722) and the upstream portions of the modulating pintle (222) to be tuned so to produce a specific deflection capacity. In one exemplary embodiment, the pintle flexure (722) has a diameter of approximately 1.37 mm (0.054 inches). In this exemplary embodiment, the second cylindrical section (327) has a diameter of approximately 3.175 mm (0.125 inches), such that the ratio of the flexure diameter to the second section diameter is approximately 0.43:1. Additionally, the pintle flexure (722) may have a length configured to allow for a (radial) deflection of approximately 0.18 mm (0.007 inches).

With continued reference to FIG. 10, the structural components of the pintle drive interface (e.g., the mechanical assembly and structural coupling configured to translate motion from the actuator to the pintle) are shown in a sequential arrangement along the centerline, CL. To reduce clutter, reference numerals are primarily illustrated for the view on the left, it being understood that these numerals apply to the corresponding structures shown in the view on the right. As illustrated from left to right in each view of FIG. 10, the interface comprises a first bushing (725) (e.g., a PEEK/PTFE bushing) and a slip-fit structure (720) (e.g., a close clearance slip-fit). As previously described, the housing (310) (e.g., a cavitating venturi housing) defines the internal cavity (312) through which the modulating pintle (222) translates. Positioned downstream of the housing (310), the interface further includes a seal gland (745) (e.g. a PEEK/PTFE seal gland) that doubles as a second bushing.

With further reference to FIG. 10, a mechanical housing (272) (e.g., a structural envelope of the translational guidance subassembly) is positioned at the downstream end of the interface and encloses a guide bushing (274) and an output drive shaft (256) (e.g., of the motion conversion subassembly). The output drive shaft (256) is mechanically coupled to the pintle flexure (722) to translate the modulating pintle (222) along the centerline, CL. The mechanical compliance provided by the pintle flexure (722) ensures that the first and second bushings (725, 745) and the slip-fit structure (720) remain the primary alignment features for the modulating pintle (222) within the housing (310). By decoupling the modulating pintle (222) from the mechanical drive train (e.g., as described with reference to FIG. 8), this configuration allows the modulating pintle (222) to remain coaxially aligned within the internal cavity (312) even if the output drive shaft (256) or mechanical housing (272) experience centerline offsets or angular misalignment.

A number of embodiments of the disclosure have been described. Nevertheless, it will be understood that various modifications may be made without departing from the spirit and scope of the present disclosure. Accordingly, other embodiments are within the scope of the following claims.

The examples set forth above are provided to those of ordinary skill in the art as a complete disclosure and description of how to make and use the embodiments of the disclosure and are not intended to limit the scope of what the inventor/inventors regard as their disclosure.

Modifications of the above-described modes for carrying out the methods and systems herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is to be understood that the disclosure is not limited to particular methods or systems, which can, of course, vary. It is also to be understood that the terminology used herein is for the purpose of describing particular embodiments only and is not intended to be limiting. As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

1. A throttle valve for fluid modulation, comprising:
a housing defining a centerline and a converging inlet, the converging inlet having a converging half-angle relative to the centerline and terminating at a throat for downstream flow of a fluid; and
a modulating pintle aligned with the centerline and comprising a bulb and a downstream extension,
wherein the modulating pintle is translatable along the centerline between:
a first position where the bulb contacts the converging inlet to prevent the downstream flow through the throat; and
a second position where the bulb is distant from the converging inlet to define a radial spacing between the downstream extension of the modulating pintle and the throat, the radial spacing configured to modulate the downstream flow.

2. The throttle valve for fluid modulation of claim 1, wherein:
the housing comprises an internal cavity forming a cavitating venturi, and
the internal cavity comprises the converging inlet and a diverging diffuser arranged downstream the throat.

3. The throttle valve for fluid modulation of claim 2, wherein:
the converging half-angle of the converging inlet is in a range of 25 degrees to 45 degrees.

4. The throttle valve for fluid modulation of claim 2, wherein:
the diverging diffuser defines a diverging half-angle relative to the centerline that is in a range of 3 degrees to 5 degrees.

5. The throttle valve for fluid modulation of claim 2, wherein:
the throat comprises a throat length and a throat diameter, and
a ratio of the throat length to the throat diameter is in a range of 0.1 to 0.5.

6. The throttle valve for fluid modulation of claim 1, wherein:
the bulb of the modulating pintle comprises a downstream conical surface configured to interface with the converging inlet to form a mechanical seal when the modulating pintle is in the first position.

7. The throttle valve for fluid modulation of claim 6, wherein the downstream conical surface of the bulb comprises:
a converging half-angle that is different from that of the converging inlet to provide an angular mismatch relative to the converging inlet.

8. The throttle valve for fluid modulation of claim 7, wherein:
the converging half-angle of the downstream conical surface of the bulb is greater than the converging half-angle of the converging inlet by a range of 0.5 degrees to 5 degrees.

9. The throttle valve for fluid modulation of claim 6, wherein:
the downstream conical surface of the bulb comprises a circumferential groove, and
the circumferential groove is configured to retain an elastomeric member to interface with the converging inlet when the modulating pintle is in the first position.

10. The throttle valve for fluid modulation of claim 1, wherein the downstream extension of the modulating pintle comprises:
a first cylindrical section;
a frustoconical tapered section downstream of the first cylindrical section; and
a second cylindrical section downstream of the frustoconical tapered section.

11. The throttle valve for fluid modulation of claim 10, wherein:
the first cylindrical section, the frustoconical tapered section, and the second cylindrical section are each configured to be positioned within the throat to define the radial spacing.

12. The throttle valve for fluid modulation of claim 11, wherein:
a high flow state of the fluid is provided when the second cylindrical section is positioned within the throat, and
a deep-throttling flow state is provided when the first cylindrical section is positioned within the throat.

13. The throttle valve for fluid modulation of claim 12, wherein:
the deep-throttling flow state is 10% of the high flow state.

14. The throttle valve for fluid modulation of claim 12, wherein:
the downstream flow is modulated between the deep-throttling flow state and 0% flow as the first cylindrical section translates through the throat toward the first position.

15. The throttle valve for fluid modulation of claim 14, wherein:
the 0% flow is provided when the bulb contacts the converging inlet.

16. The throttle valve for fluid modulation of claim 10, wherein:
the frustoconical tapered section defines a constant taper configured to vary the radial spacing to modulate the downstream flow relative to a translation of the modulating pintle along the centerline.

17. The throttle valve for fluid modulation of claim 16, wherein:
the downstream flow is modulated linearly relative to the translation of the modulating pintle.

18. The throttle valve for fluid modulation of claim 10, wherein the frustoconical tapered section comprises:
an upstream end with an upstream diameter equal to a diameter of the first cylindrical section; and
a downstream end with a downstream diameter equal to a diameter of the second cylindrical section.

19. The throttle valve for fluid modulation of claim 1, wherein:
the radial spacing defines an annular orifice for the downstream flow.

20. The throttle valve for fluid modulation of claim 1, wherein:
the modulating pintle further comprises a pintle flexure positioned in a downstream region of the modulating pintle relative to the downstream extension.

21. The throttle valve for fluid modulation of claim 20, wherein:
the pintle flexure is configured to deflect to maintain the coaxial alignment of the modulating pintle with respect to the centerline while accommodating a radial misalignment between the housing and an actuator assembly coupled thereto.

22. The throttle valve for fluid modulation of claim 20, wherein:
the pintle flexure is defined by a reduced diameter relative to a diameter of an adjacent section of the downstream extension.

23. The throttle valve for fluid modulation of claim 22, wherein:
a ratio of the diameter of the pintle flexure to the diameter of the adjacent section of the downstream extension is within a range of approximately 0.4:1 to 0.8:1.

24. The throttle valve for fluid modulation of claim 20, wherein:
a length-to-diameter aspect ratio between the pintle flexure and the downstream extension is configured to produce a specific radial deflection capacity.

25. The throttle valve for fluid modulation of claim 20, wherein:
the pintle flexure is mechanically coupled to an output drive shaft to translate the modulating pintle along the centerline, and
the pintle flexure provides mechanical compliance that decouples the modulating pintle from centerline offsets or angular misalignments of the output drive shaft.

26. The throttle valve for fluid modulation of claim 1, further comprising:
an actuator assembly coupled to the housing and comprising a mechanical drive train configured to translate the modulating pintle along the centerline.

27. The throttle valve for fluid modulation of claim 26, wherein the mechanical drive train comprises:
a drive power subassembly configured to generate rotational torque;
a motion conversion subassembly configured to convert the rotational torque into linear translation of the modulating pintle; and
a power transmission subassembly comprising a flexible drive geometry configured to transmit the rotational torque from the drive power subassembly to the motion conversion subassembly.

28. The throttle valve for fluid modulation of claim 27, wherein:
the flexible drive geometry of the power transmission subassembly comprises an Oldham disc configured to accommodate mechanical misalignments between the drive power subassembly and the motion conversion subassembly.

29. The throttle valve for fluid modulation of claim 27, wherein the motion conversion subassembly comprises:
a ball nut and a ball screw, wherein the ball nut is configured to drive the ball screw longitudinally in response to the rotational torque.

30. The throttle valve for fluid modulation of claim 26, wherein the mechanical drive train further comprises:
a rotational support subassembly comprising a plurality of angular contact bearings and a bearing mount configured to rotatably support rotating components of the mechanical drive train.

31. The throttle valve for fluid modulation of claim 26, wherein the mechanical drive train further comprises:
a translational guidance subassembly comprising a guide bushing configured to provide radial constraint for an output drive shaft coupled to the modulating pintle.

32. The throttle valve for fluid modulation of claim 26, wherein:
the mechanical drive train further comprises a stroke limit subassembly comprising a positive bumper configured to define a physical boundary for a fully extended position of the modulating pintle, and
a fully retracted position of the modulating pintle is defined by mechanical contact between the bulb and the converging inlet.

33. The throttle valve for fluid modulation of claim 1, further comprising:
an actuator assembly coupled to the housing; and
a magnetic circuit positioned within the actuator assembly and configured to provide a passive fail-closed and locking feature for the modulating pintle.

34. The throttle valve for fluid modulation of claim 33, wherein the magnetic circuit comprises:
a magnet and a magnetic shaft pole configured to translate with the modulating pintle,
wherein the magnet generates a magnetic force configured to bias the modulating pintle toward the first position to engage the bulb with the converging inlet.

35. The throttle valve for fluid modulation of claim 34, wherein:
a proximity between the magnetic shaft pole and a stationary magnetic circuit pole reduces magnetic reluctance of the magnetic circuit when the modulating pintle is in the first position to create a latched state.

36. The throttle valve for fluid modulation of claim 35, wherein:
the latched state provides a latching force that is sufficient to maintain the modulating pintle in the first position to prevent the downstream flow through the throat during a power loss or a launch environment.

37. The throttle valve for fluid modulation of claim 2, wherein:
the internal cavity is configured to induce cavitation at the throat to decouple a flow rate of the fluid from downstream pressure fluctuations.

38. The throttle valve for fluid modulation of claim 1, wherein:
at least internal surfaces of the housing and the modulating pintle in contact with a fluid flow path are constructed from hydrazine-compatible materials.

39. The throttle valve for fluid modulation of claim 38, wherein:
the hydrazine-compatible materials comprise at least one of a hydrazine-compatible corrosion-resistant steel, a hydrazine-compatible titanium alloy, or a hydrazine-compatible polymeric material.

40. The throttle valve for fluid modulation of claim 1, wherein:
the housing and the modulating pintle each comprise a monolithic structure.

41. An integrated throttle valve system for propellant flow modulation, comprising:
a housing defining a centerline and an internal cavity forming a cavitating venturi, the internal cavity comprising a converging inlet, a throat, and a diverging diffuser arranged sequentially along the centerline;
a modulating pintle translatable along the centerline within the internal cavity and comprising a bulb;
an actuator assembly coupled to the housing and comprising a mechanical drive train configured to translate the modulating pintle to define a variable annular orifice between the modulating pintle and the throat to modulate a propellant flow; and
a magnetic circuit positioned within the actuator assembly and configured to generate a passive latching force that biases the modulating pintle toward a position where the bulb contacts the converging inlet to provide positive isolation of the propellant flow in a fail-closed state.

42. A method for propellant flow modulation in a spacecraft propulsion system, the method comprising:
translating a modulating pintle along a centerline of a housing to define a variable annular orifice between the modulating pintle and a throat of the housing;
inducing cavitation at the throat to decouple a propellant flow from downstream pressure fluctuations;
modulating the propellant flow through a linear range of at least 10:1 based on a longitudinal position of the modulating pintle; and
biasing a bulb of the modulating pintle toward a converging inlet of the housing using a passive magnetic force to form a fluidic seal for positive isolation of the propellant flow during a non-operational state.
